(19) United States
(12) Patent Application Publication
(10) Pub. No.: US 2025/0118862 A1
(43) Pub. Date: Apr. 10, 2025

(54) ZEOLITE COATED ON ELECTRODES FOR BATTERIES

(71) Applicant: Pacific Industrial Development Corporation, Ann Arbor, MI (US)

(72) Inventors: Bing Tan, Ann Arbor, MI (US); Wei Wu, Ann Arbor, MI (US); David Shepard, Canton, MI (US); Ashwin Sankaran, Arnhem (NL); Yunkui Li, Ann Arbor, MI (US)

(21) Appl. No.: 18/695,507

(22) PCT Filed: Sep. 28, 2022
(86) PCT No.: PCT/US2022/044984

§ 371 Date: Mar. 26, 2024

Related U.S. Application Data
(60) Provisional application No. 63/251,745, filed on Oct. 4, 2021.

(51) Int. Cl. H01M 50/431; H01M 4/02; H01M 4/485; H01M 4/505; H01M 4/62; H01M 10/0525

(52) U.S. Cl. CPC H01M 50/431; H01M 4/485; H01M 4/505; H01M 4/623; H01M 4/625; H01M 10/0525; H01M 2004/027; H01M 2004/028

(57) ABSTRACT

A cell for use in an electrochemical cell, that includes a positive electrode, a negative electrode, an electrolyte, and a separator in the form of a zeolite-based material comprising one or more naturally occurring or synthetically synthesized zeolites applied directly to at least one of the positive electrode and the negative electrode. The positive electrode configured so that non-reactive metal ions are reversibly extracted there from and inserted therein. The negative electrode configured to reversibly accept and release the non-reactive metal ions. The electrolyte positioned between and in contact with the negative electrode and the positive electrode, such that the electrolyte supports a reversible flow of the non-reactive metal ions between the positive electrode and the negative electrode. The separator being configured to electrically isolate the positive electrode from the negative electrode, while being permeable to the reversible flow of the non-reactive metal ions there through.

### CROSS-REFERENCE TO RELATED APPLICATIONS

This application claims the benefit of the filing date under 35 U.S.C. § 119 (e) of U.S. Provisional Application No. 63/251,745 filed Oct. 4, 2021, the entire contents of which is hereby incorporated herein by reference.

### FIELD

This invention generally relates to components used in the manufacture of electrochemical cells. More specifically, the present disclosure describes a separator in the form of a zeolite-based material applied to one or more of the electrodes present in a battery.

### BACKGROUND

The statements in this section merely provide background information related to the present disclosure and may not constitute prior art.

The main difference between a lithium-ion battery and a lithium-ion secondary battery is that the lithium-ion battery represents a battery that includes a primary cell and a lithium-ion secondary battery represents a battery that includes a secondary cell. The term “primary cell” refers to a battery cell that is not easily or safely rechargeable, while the term “secondary cell” refers to a battery cell that may be recharged. As used herein a “battery cell” or “cell” refers to the basic electrochemical unit of a battery that contains the electrodes, separator, and electrolyte. In comparison, a “battery” refers to a collection of cell(s), e.g., one or more cells, and includes a housing, electrical connections, and possibly electronics for control and protection.

Since lithium-ion (e.g., primary cell) batteries are not rechargeable, their current shelf life is about three years, after that, they are worthless. Even with such a limited lifetime, lithium batteries can offer more in the way of capacity than lithium-ion secondary batteries. Lithium batteries use lithium metal as the anode of the battery unlike lithium ion batteries that can use a number of other materials to form the anode.

One key advantage of lithium-ion secondary cell batteries is that they are rechargeable several times before becoming ineffective. The ability of a lithium-ion secondary battery to undergo the charge-discharge cycle multiple times arises from the reversibility of the redox reactions that take place. Lithium-ion secondary batteries, because of the high energy density, are widely applied as the energy sources in many portable electronic devices (e.g., cell phones, laptop computers, etc.), power tools, electric vehicles, and grid energy storage.

As shown in FIG. 1, a conventional electrochemical cell 1, such as a secondary cell for a lithium-ion battery, generally comprises a positive electrode 10 including an active material (cathode) 5 and a current collector 7, a non-aqueous electrolyte 30 containing lithium ions 35, a separator 25, and a negative electrode 20 including an active material (anode) 15 and a current collector 17. All of these components are sealed in a case, an enclosure, a pouch, a bag, a cylindrical shell, or the like (generally called the battery's “housing”). The separator 25 electrically insulates the cathode 5 from the anode 15, while still allowing ions 35 to flow between them. The flow of ions may be conducted by the separator (i.e., via a solid-state mechanism) or by the presence of a liquid electrolyte 30 that permeates through the porosity of the separator 25 (e.g., a membrane).

In lithium ion or lithium metal batteries, the separators generally comprise polymer-based materials, such as polyethylene (PE), polypropylene (PP), polytetrafluoroethylene (PTFE), and nonwoven fabrics formed with polymeric fibers, because of their high mechanic strength and electrochemical stability. However, various issues also exist for these polymeric materials. For example, polymer-based separators are wet poorly by the non-aqueous electrolyte, wherein the impedance for ion transport increases resulting in a poor high-rate capability. In addition, these polymer-based separators generally lack thermal stability. More specifically, these polymeric materials tend to shrink and even melt at relatively high temperatures (e.g. ≤165° C.). Due to the organic nature of the polymeric materials, these separators may also ignite and burn during a thermal runaway event. Furthermore, the softness of the polyolefin membrane allows for the growth and penetration of dendrites, e.g., lithium dendrites, which adds to the concern for safety.

The substitution of polymeric materials with pure inorganic materials (e.g., ceramic oxides or glass) can improve the thermal stability of the separator by avoiding the potential softening and melting issue encountered upon exposure to high temperatures. However, such separators formed from pure inorganic materials tend to exhibit poor mechanic stability (e.g., become brittle, etc.). In addition, the manufacturing process for these separators becomes more complicated and expensive due to the difficulty associated with making flexible, free standing, thin films of an inorganic material.

Simplification of the manufacturing process can result upon the application of the pure inorganic materials directly onto the surface of a polymer-based separator. These pure inorganic materials represent solid ceramic oxide particles of α-Al₂O₃, ZrO₂, TiO₂, or SiO₂ that provide limited electrical insulation for the electrodes, while allowing ions to diffuse through the inter-particle spaces that exist. However, these solid ceramic oxide particles have limited surface area and functionality to act as functional particles capable of improving the performance of the cell.

Zeolite particles and lithium-ion exchanged zeolite particles may be used to remove the moisture, dissolved transitional metal ions, and impurities from the electrolyte in order to improve the cell's performance. However, the application of these high surface area particles onto the surface of electrodes is problematic because many of these zeolite materials tend to hold a significant amount of moisture even after drying. The high content of moisture in the zeolite particles may be released to the electrolyte in a cell, which will be detrimental to the performance of the cell since the moisture will be reduced irreversibly to H₂ upon the 1^{st} charging step. Since this reduction consumes electrons irreversibly, the end result is a poor 1^{st} Coulombic Efficiency and a decrease in the cell's energy density.

### SUMMARY

This disclosure relates generally to a cell for use in an electrochemical cell that addresses and overcomes the problems and inefficiencies of the conventional art. In general an electrochemical cell is provided that comprises a positive electrode, a negative electrode, an electrolyte positioned between and in contact with the negative electrode and the positive electrode, and a separator in the form of a zeolite-based material comprising one or more naturally occurring or synthetically synthesized zeolites applied directly to at least one of the positive electrode and the negative electrode. The positive electrode is configured so that non-reactive metal ions are reversibly extracted there from and inserted therein. The negative electrode is configured to reversibly accept and release the non-reactive metal ions. The electrolyte supports a reversible flow of the non-reactive metal ions between the positive electrode and the negative electrode. The separator is configured to electrically isolate the positive electrode from the negative electrode, while being permeable to the reversible flow of the non-reactive metal ions there through.

According to one aspect of the present disclosure, the zeolite-based material applied to the at least one of the positive electrode and negative electrode has a thickness in the range from 1 micrometers (μm) to 200 μm. When desirable, the zeolite-based material further comprises a binder, such that the ratio of the zeolites to the binder is in a mass ratio ranging from 99.5%/0.5% to 10%/90%. This binder may comprise an organic complex, an inorganic oxide, or an inorganic hydroxide. This organic complex may be PVDF, cmc, SBR, PTFE, PAA (polyacrylic acid), PVA, PEI, or PAI; wherein the inorganic oxide or the inorganic hydroxide may include aluminum, magnesium, zirconium, or cerium as an element thereof. The zeolites may have an aluminum to silicon ratio (SAR) that is in the range of 0.5 to 500.

The positive electrode comprises an active material as a cathode and a current collector that is in contact with the cathode; wherein the active material comprises one or more of LMNO, LiMn₂O₄, LiFePO₄, LiNiₐCo_{b}Mn_{c}Al_{d}O₂ (a+b+c+d=1), and LiFe_{0.2}Mn_{0.8}PO₄. The negative electrode comprises an active material as an anode and a current collector that is in contact with the anode; wherein the active material comprises one or more of graphite, hard carbon, soft carbon, silicon, Li₄Ti₅O₁₂, Nb₂O₅, and derivatives thereof. The negative electrode may be an “anode-free” electrode and comprises only a current collector. The zeolite-based material may have a moisture content that is 35% or less, alternatively, 7% or less. The zeolite-based material may also have a porosity that is 55% or less, alternatively, in the range of 30% to 36%. The non-reactive metal ion in the electrolyte is lithium, sodium, potassium, magnesium, calcium, aluminum, or a mixture thereof.

According to another aspect of the present disclosure, the zeolite-based material may further comprise one or more secondary materials. The ratio of the zeolites to the secondary materials is in a mass ratio ranging from 99.9%/0.1% to 50.1%/49.9%. When desirable, the one or more secondary materials includes a flame retardant material.

The zeolites may have an average particle size that is in the range of 50 nanometers (nm) to 30 micrometers (μm) and/or an average pore size that is in the range of 0.1 nm to 20 nm. When desirable, the zeolites may comprise one or more ion-exchanged zeolites. The ion-exchanged zeolites may be lithium-exchanged zeolites. In other words, the lithium-exchanged zeolites may comprise a lithium mass content that is in the range of 0.1 wt. % to 20 wt. % relative to the overall weight of the lithium-exchanged zeolites.

According to yet another aspect of the present disclosure, a lithium-ion secondary battery is provided that comprises: one or more cells as previously described and as further defined herein; and one or more housings, such that an internal wall from one of the one or more housings encapsulates at least one or more of the cells.

Further areas of applicability will become apparent from the description provided herein. It should be understood that the description and specific examples are intended for purposes of illustration only and are not intended to limit the scope of the present disclosure.

### DESCRIPTION OF THE DRAWINGS

In order that the disclosure may be well understood, there will now be described various forms thereof, given by way of example, reference being made to the accompanying drawings. The components in each of the drawings may not necessarily be drawn to scale, but rather emphasis is placed upon illustrating the principles of the invention.

FIG. 1 is a schematic representation of a conventional electrochemical cell;

FIG. 2 is a graphical plot using thermal gravimetric analysis (TGA) to compare the moisture content (%) as a function of temperature for a zeolite before and after drying.

FIG. 3A is a schematic representation of an electrochemical cell formed according to the teachings of the present disclosure in which a zeolite-based material applied directly to the negative electrode functions as a separator.

FIG. 3B is a schematic representation of the electrochemical cell of FIG. 3A shown as a lithium-ion secondary cell formed according to the teachings of the present disclosure.

FIG. 3C a schematic representation of another lithium-ion secondary cell formed according to the teachings of the present disclosure, wherein a zeolite-based material applied directly to the positive electrode functions as a separator.

FIG. 3D a schematic representation of another lithium-ion secondary cell formed according to the teachings of the present disclosure, wherein a zeolite-based material applied directly to both the negative and positive electrodes functions as a separator.

FIG. 4 is a schematic representation of a lithium-ion secondary battery formed according to the teachings of the present disclosure showing the layering of four secondary cells of FIG. 3B in parallel to form a larger multiple cell battery.

FIG. 5 is a schematic representation of another lithium-ion secondary battery showing the layering of four secondary cells including secondary cells of FIGS. 3A, 3B, 3C, 3D in series to form a larger mixed cell battery.

FIG. 6 is a graphical comparison of the charge/discharge curves for a LiMn₂O₄/Li₄Ti₅O₁₂ full cell having either a PE separator or a zeolite coated electrode.

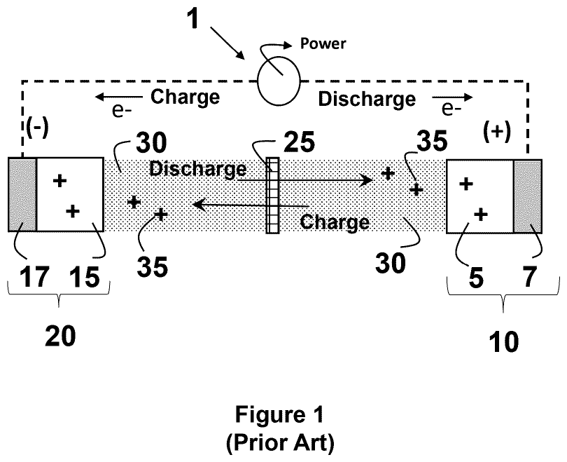

The drawings described herein are for illustration purposes only and are not intended to limit the scope of the present disclosure in any way. It should be understood that throughout the description and drawings, corresponding reference numerals indicate like or corresponding parts and features.

### DETAILED DESCRIPTION

The following description is merely exemplary in nature and is in no way intended to limit the present disclosure or its application or uses. For example, the zeolite-based materials prepared and used according to the teachings contained herein are described throughout the present disclosure as separators applied to or in direct contact with one or more electrodes within a secondary lithium-ion battery in order to more fully illustrate the structural elements and the use thereof. The incorporation and use of such zeolite-based materials in direct contact with or located on the surface of electrodes may be used in other applications, including without limitation at least as an electrode/separator combination in other electrochemical cells, solid-state batteries, or primary cell batteries, and is contemplated to be within the scope of the present disclosure.

For the purpose of this disclosure, the terms “about” and “substantially” are used herein with respect to measurable values and ranges due to expected variations known to those skilled in the art (e.g., limitations and variability in measurements).

For the purpose of this disclosure, the terms “at least one” and “one or more of” an element are used interchangeably and may have the same meaning. These terms, which refer to the inclusion of a single element or a plurality of the elements, may also be represented by the suffix “(s)” at the end of the element. For example, “at least one metal”, “one or more metals”, and “metal(s)” may be used interchangeably and are intended to have the same meaning.

The present disclosure generally provides a zeolite-based material applied directly to or coated onto the surface of one or more electrodes functions as a separator layer in an electrochemical cell, such as for example, a secondary, lithium-ion battery. The use of this zeolite-based material provides the benefits of improving or enhancing the thermal stability of the separator. The zeolite-based materials also provide a large amount of pore surface area and volume for electrolyte in-situ purification and for the incorporation of other functions, such as, without limitation, support for the inclusion or attachment of catalysts and/or flame-retardants.

As compared to conventional ceramic oxides, e.g., α-Al₂O₃, ZrO₂, TiO₂, or SiO₂, the zeolite-based material of the present disclosure is capable of performing a variety of additional functions based on the pore size, Si/Al ratio, and chemical compositions of the zeolites contained therein. Zeolite-based materials may be used as the support for other active materials because of the adjustable pore structure, and pore functions associated with the zeolites including reversible ion exchange sites. For example, lithium-exchanged zeolites also provide the function of capturing dissolved transition metal ions present in a battery, thereby, extending the battery life-cycle. Due to the zeolites' extra high surface area as compared to conventional ceramic oxides, the zeolites can absorb a much larger amount of moisture and impurities from the organic electrolyte, which is necessary in order to extend the cycling life of the battery.

The zeolites present in the zeolite-based material of the present disclosure are crystalline or quasi-crystalline aluminosilicates comprised of repeating TO₄ tetrahedral units with T being most commonly silicon (Si) or aluminum (Al). These repeating units are linked together to form a crystalline framework or structure that includes cavities and/or channels of molecular dimensions within the crystalline structure. Thus, these aluminosilicate zeolites comprise at least oxygen (O), aluminum (AI), and silicon (Si) as atoms incorporated in the framework structure thereof. Since zeolites exhibit a crystalline framework of silica (SiO₂) and alumina (Al₂O₃) interconnected via the sharing of oxygen atoms, they may be characterized by the ratio of SiO₂:Al₂O₃ (SAR) present in the crystalline framework.

The zeolites may exhibit any framework topography known in the art, including but not limited to a chabazite (framework notation=“CHA”), chiavennite (CHI), faujasite (FAU), linde type A (LTA), and laumontite (LAU). The framework notation represents a code specified by the International Zeolite Associate (IZA) that defines the framework structure of the zeolite. Thus, for example, a chabazite means a zeolite in which the primary crystalline phase of the zeolite is “CHA”.

The crystalline phase or framework structure of a zeolite may be characterized by X-ray diffraction (XRD) data. However, the XRD measurement may be influenced by a variety of factors, such as the growth direction of the zeolite; the ratio of constituent elements; the presence of an adsorbed substance, defect, or the like; and deviation in the intensity ratio or positioning of each peak in the XRD spectrum. Therefore, a deviation of 10% or less; alternatively, 5% or less; alternatively, 1% or less in the numerical value measured for each parameter of the framework structure for each zeolite as described in the definition provided by the IZA is within expected tolerance.

According to one aspect of the present disclosure, the zeolites may include natural zeolites, synthetic zeolites, or a mixture thereof. Alternatively, the zeolites are synthetic zeolites because such zeolites exhibit greater uniformity with respect to SAR, crystallite size, and crystallite morphology, as well as having fewer and less concentrated impurities (e.g. alkaline earth metals). The zeolites may be selected to be one or more types of a zeolite having a silicon (Si) to aluminum (Al) ratio (SAR) ranging from about 0.5 to 500; alternatively, about 1 to about 250; alternatively, about 1 to about 100; alternatively, in the range of about 2 and 50.

The zeolites in the zeolite-based material of the present disclosure may comprise a plurality of particles having or exhibiting a morphology that is plate-like, cubic, spherical, or a combination thereof. Alternatively, the morphology is predominately, spherical in nature. These particles may exhibit an average particle size (D₅₀) that is in the range of about 50 nanometers (nm) to about 30 micrometers (μm); alternatively about 100 nanometers (nm) to about 25 micrometers (μm); alternatively, 500 nanometers (nm) to about 20 micrometers (μm); alternatively, 1 micrometer (μm) to about 5 micrometers (μm). Scanning electron microscopy (SEM) or other optical and digital imaging methodology known in the art may be used to determine the shape and/or morphology of the inorganic additive. The average particle size and particle size distributions may be measured using any conventional technique, such as sieving, microscopy, Coulter counting, dynamic light scattering, or particle imaging analysis, to name a few. Alternatively, a laser particle analyzer is used for the determination of average particle size and its corresponding particle size distribution.

The zeolites in the zeolite-based material may also exhibit a surface area that is in the range of about 1 m²/g to about 7500 m²/g; alternatively, about 3 m²/g to about 5000 m²/g; alternatively from about 5 m²/g to about 2500 m²/g; alternatively, from about 10 m²/g to about 1000 m²/g; alternatively, about 25 m²/g to about 750 m²/g. The average pore size of the zeolites in the zeolite-based material is in the range of 0.1 nm to 20 nm; alternatively, between about 0.5 nm and about 15 nm with a pore volume that is in the range of about 0.05 cc/g to about 3.0 cc/g; alternatively, 0.1 cc/g to about 2.0 cc/g. The measurement of surface area and pore volume for the zeolites in the zeolite-based material may be accomplished using any known technique, including without limitation, microscopy, small angle x-ray scattering, mercury porosimetry, and Brunauer, Emmett, and Teller (BET) analysis. Alternatively, the surface area and pore volume are determined using Brunauer, Emmett, and Teller (BET) analysis.

The zeolite-based material may include a sodium (Na) concentration of about 0.01 wt. % to about 2.0 wt. % based on the overall weight of the zeolite-based material. Alternatively, the Na concentration may range from about 0.1 wt. % to about 1.0 wt. %. The zeolite-based material may comprise one or more ion-exchanged zeolites. These ion-exchanged zeolites may comprise, without limitation, lithium-ion exchanged zeolites, such that the concentration of the lithium ion is about 0.05 wt. % to about 25 wt. %; alternatively, about 0.1 wt. % to about 20 wt. %; alternatively, about 0.2 wt. % to about 15 wt. %, based on the overall weight of the zeolites, e.g., the lithium-ion exchanged zeolites present in the zeolite-based material. When desirable, the zeolites in the zeolite-based material may further include one or more doping elements selecting from Li, Na, Al, Mn, Sm, Y, Cr, Eu, Er, Ga, Zr, and Ti.

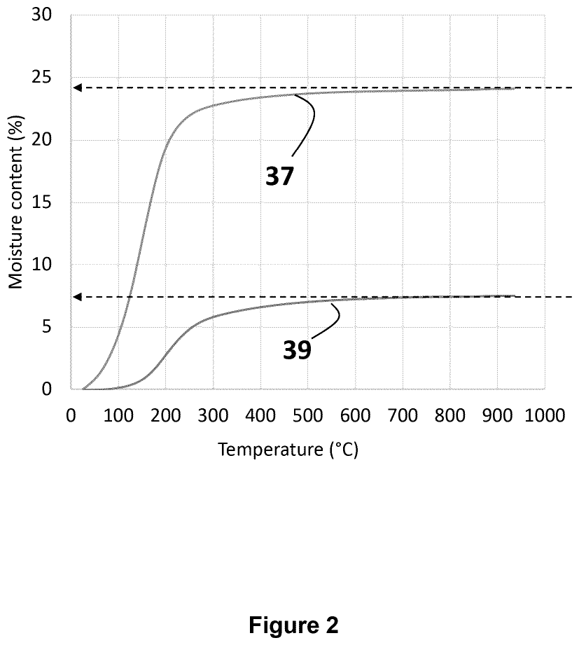

Referring to FIG. 2, the zeolite-based material may initially have a moisture content of about 23 wt. % prior to or without drying 37. The moisture content may be reduced to about 7.5 wt. % after drying 39 at 80° C. in vacuum for at least a few hours (e.g., 2-7 hours); alternatively, the drying time is 7 hours or greater. The drying time shown for the dried zeolite-based material 39 in FIG. 2 is 7 hours. This water content is considered to be very high for a conventional battery since the general moisture content from cell components (cathode, anode and separator) are on the scale of a few hundreds of ppm. However, with the high moisture content shown in FIG. 2, a LiMn₂O₄/Li₄Ti₅O₁₂ full cell with a zeolite coated electrode exhibits similar Coulombic Efficiency (CE) at the 1^{st} cycle (93%) as a corresponding cell with a commercial PE separator. The zeolite coating has a thickness about 30-40 μm with 90 wt. % of the zeolite and 10 wt. % of a binder. Thus, a full cell with the zeolite coating on an electrode as the separator may be fabricated according to the present disclosure to perform as well as a conventional full cell even though there is a significant amount of moisture contained in the zeolite.

The zeolite-based material may have a moisture content that is higher than 23 wt. % without drying. However, a lower moisture content in general is preferred. The zeolite-based material may have a moisture content of ≤35 wt. %. Alternatively, the moisture content is ≤23 wt. %; alternatively, the moisture content is ≤11 wt. %; alternatively, the moisture content is ≤7 wt. %.

Free-standing zeolite films having a relatively thin thickness are very difficult to make because of the brittle nature of the inorganic film. In comparison, it is more practical to apply or coat a zeolite layer onto an existing electrode. In production, a cathode or anode may be formed as part of an electrode using a roll-to-roll coating process with a double-layer coating or multi-layer coating process. In other words, the electrode is formed by applying a coating of at least one layer of an active material that can act as a cathode or anode. Similar double-layer coating or multi-layer coating processes may be used to coat the zeolite-based material onto an existing electrode (e.g., a cathode or an anode) layer.

The zeolite-based material may be applied directly to the surface of or on top of an electrode layer. However, ensuring that the applied zeolite layer functions as a separator is more challenging because the separator needs to insulate the cathode and anode electrically not only during the battery fabrication process, but also during the battery usage period. In comparison to most commercially available porous PP/PE separators, which generally exhibit a porosity in the range of 37% to 55%, the porosity of a zeolite-based material or coating tends to be larger without the use of calendaring. For example, the porosity of a typical zeolite-based material or coating may generally be as high as about 73% for an as-coated zeolite film comprising 7 wt. % of a binder and 93 wt. % of a zeolite. Due to this high level of porosity, a typical zeolite-based material or coating may not provide adequate electrical isolation of the anode from the cathode during cycling. However, the porosity of the zeolite-based material of the present disclosure may be controlled such that the resulting coating or layer exhibits at least the same porosity level as the commercially available PP/PE separators, which is between about 37% to 55%; alternatively, less than or equal to 55%. When desirable, the porosity of the zeolite-based material of the present disclosure may be even lower, for example in the range of about 30% to 36%. The porosity of the zeolite-based material may be controlled by adjusting the coating formulation. For example, particles with a bimodal or trimodal particle size distribution may be used in the coating formulation. The internal space between the larger particles may be filled with the smaller particles in order to reduce the porosity of the coating. The porosity may also be reduced by increasing the polymer binder/zeolite mass ratio. With an increase in the polymer content, the coating porosity is reduced because the polymer molecules fill the empty internal spaces that exit between the zeolite particles. In one extreme case, the coating of a pure polymer film may have negligible porosity.

Since the zeolite-based material or coating is applied onto a relatively hard subject (e.g., electrode), adjustment of the porosity may be achieved by mechanically compressing the zeolite-based coating to reduce its porosity. This process is called calendaring within the battery industry. This calendaring step for the zeolite-based coating may be performed on an un-calendared electrode coating layer, a partially calendared electrode coating layer, or a fully calendared electrode coating layer at a temperature ranging from room temperature to about 140° C. The evaluation of the coating porosity may be carried out by measuring the coating areal mass loading and its thickness. Using the true density of the zeolite-based materials, the coating thickness at 0% porosity can be calculated with the known equation for areal mass loading/density. Then, the coating porosity is calculated by using the equation of (1-coating thickness at 0% porosity/measured thickness)*100%.

As compared to commercially available PP/PE separators, the tortuosity of the zeolite-based material or coating of the present disclosure is expected to be less. This means that lithium dendrites may more easily form and penetrate through the zeolite layer since they will meet less resistance. Therefore, the coating thickness of the zeolite-based material should be thicker than the PP/PE separators with similar porosity. In general, a zeolite-based material having a thickness of 1 micrometer (μm) to 200 μm is used; alternatively, the thickness of the zeolite-based material is in the range of 20 μm to 80 μm with a porosity that is in the range of 30% to 55%. Alternatively, the thickness of the zeolite-based material or coating is in the range of 40 μm-60 μm.

In one example, the zeolite-based material or coating has a thickness range of 20-100 μm and a porosity of 30-55% when the battery has no pre-deposited anode (i.e. anode-free) or lithium metal anode. Alternatively, the thickness is in the range of 40 micrometers to 100 μm with a porosity of 30-55% considering the extra mechanic strength that is necessary to block the lithium dendrites during cycling. In another example, the thickness of the zeolite-based material is in the range of 1-100 μm, alternatively about 10-80 μm with a porosity that is in the range of 30-55% for batteries having a graphite, Li₄Ti₅O₁₂, Nb₂O₅, or silicon anode.

The zeolite-based material or coating is applied only onto the cathode of the positive electrode. Alternatively, the zeolite coating is applied only onto the anode of the negative electrode. Alternatively, the zeolite coating is applied onto both the cathode and the anode of the positive and negative electrodes, respectively. Since the function of the zeolite-based material is to electrically insulate the cathode electrode from the anode electrode, as long as it is coated between the cathode and the anode active layers, it can effectively serve this purpose. However, since the cathode and the anode have different electrode thicknesses and different binder compositions, it is desirable to coat the zeolite coating onto one of the electrodes or onto both of the electrodes. For example, in high energy EV cells, the areal capacity loading of the anode and cathode is very high (e.g., >4.4 mAh/cm²). With this high areal capacity loading, the cathode electrode may be very thick (e.g., >170 μm). Such a thick electrode will tend to crack without the application of an additional coating. In addition, if the zeolite-based material or coating is applied to this thick electrode, the coating may crack and/or peel-off the entire electrode or a portion thereof.

In another example, NMP is used as the solvent for the application of the cathode in the positive electrode. If the slurry used to form the zeolite-based material contains NMP as a solvent, the wet zeolite coating will partially dissolve the existing cathode active layer, thereby, damaging the positive electrode. In this case, it is necessary to choose a slurry composition that does not include NMP in order to coat the zeolite-based material directly onto the cathode. A slurry used to form the zeolite-based material that includes NMP as a solvent, however, could be used to apply such zeolite-based material onto the anode, since a graphite electrode is generally prepared using an aqueous slurry. The cmc and SBR binder incorporated into a graphite anode does not dissolve in NMP

The active materials in the positive electrode 10 and the negative electrode 20 may be any material known to perform this function in a lithium-ion secondary battery. The active material used in the positive electrode 10 may include, but not be limited to, lithium transition metal oxides or transition metal phosphates. Several examples of active materials that may be used in the positive electrode 10 include, without limitation, LiCoO₂, LiMn₂O₄, LiFePO₄, NCM, NCA, NCMA, LiNiₐCo_{b}Mn_{c}Al_{d}O₂ (a+b+c+d=1), LiFe_{0.2}Mn_{0.8}PO₄, and LiVPO or LMNO. The active materials used in the negative electrode 15 may include, but not be limited to graphite, hard carbon, soft carbon, Nb₂O₅, Li₄Ti₅O₁₂, as well as silicon and lithium metal and/or derivatives thereof. Alternatively, the active material for use in the negative electrode is silicon or lithium metal due to their one-magnitude higher specific capacities. Alternatively, the anode active material is lithium or there is no anode active material when the battery is fabricated.

The current collectors 7, 17 in both the positive 10 and negative 20 electrodes may be made of any metal known in the art for use in an electrode of a lithium battery, such as for example, aluminum for the cathode and copper for the anode. The cathode 5 and anode 15 in the positive 10 and negative 20 electrodes are generally made up of two dissimilar active materials.

When desirable, the zeolite-based material or coating may further comprise a binder to bind the zeolite particles together and assist in adherence onto the electrode. The binder may be selected from any known conventional binders generally used for lithium ion batteries that comprise an organic complex, an inorganic oxide, or an inorganic hydroxide. Several examples of suitable organic complexes include, but are not limited to, PVDF, cmc, SBR, PTFE, PAA (polyacrylic acid), PVA, PEI, and PAI. The mass ratio between the zeolite and the binder is should be in the range of 99.5%/0.5% to 50%/50%; alternatively, in the range of 90%/10% to 60%/40%. The zeolite-based material or coating generally is more flexible with a higher content of the binder. The binder could also be an inorganic oxide or hydroxide that includes, without limitation, comprising one or more elements selected from Al, Zr, Mg, Ti, and Ce. A zeolite-based material comprising a high content of binder is preferred for application to the anode, which is more susceptible to the generation of lithium dendrites during cycling.

The electrolyte 30 is used to support the oxidation/reduction process and provide a medium for non-reactive metal ions to flow between the anode 15 and cathode 5. The electrolyte 30 may be a solution of a non-reactive metal salt in an organic solvent, such that the salt dissolves to form the non-reactive metal ions. The non-reactive metal that forms the ions in the electrolyte may be lithium, sodium, potassium, magnesium, calcium, aluminum, or a mixture thereof. Alternatively, the non-reactive metal salt is a lithium salt. Several specific examples of lithium salts, include, without limitation, lithium hexafluorophosphate (LiPF₆), lithium bis (oxalato)-borate (LiBOB), and lithium bis (trifluoro methane sulfonyl) imide (LiTFSi). These lithium salts may form a solution with an organic solvent, such as, for example, ethylene carbonate (EC), ethyl methyl carbonate (EMC), diethyl carbonate (DEC), dimethyl carbonate (DMC), propylene carbonate (PC), vinylene carbonate (VC), and fluoroethylene carbonate (FEC), to name a few. A specific example of an electrolyte is a 1 molar solution of LiPF₆ in a mixture of ethylene carbonate and diethyl carbonate (EC/DEC=50/50 vol.).

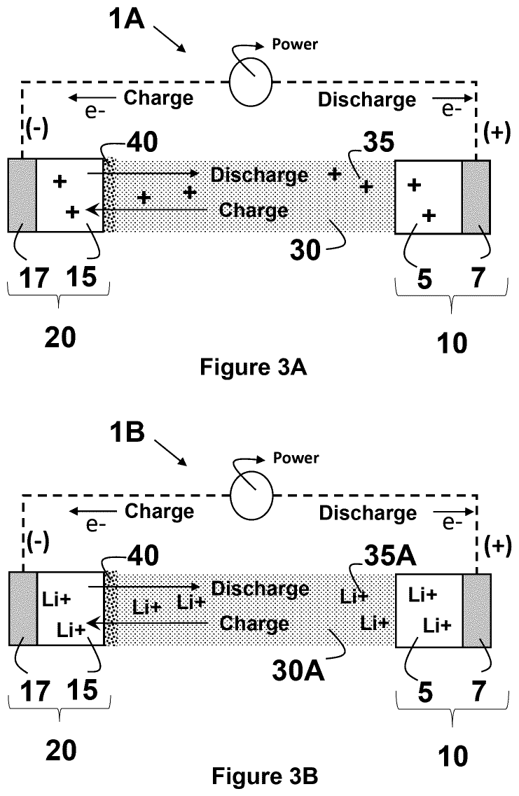

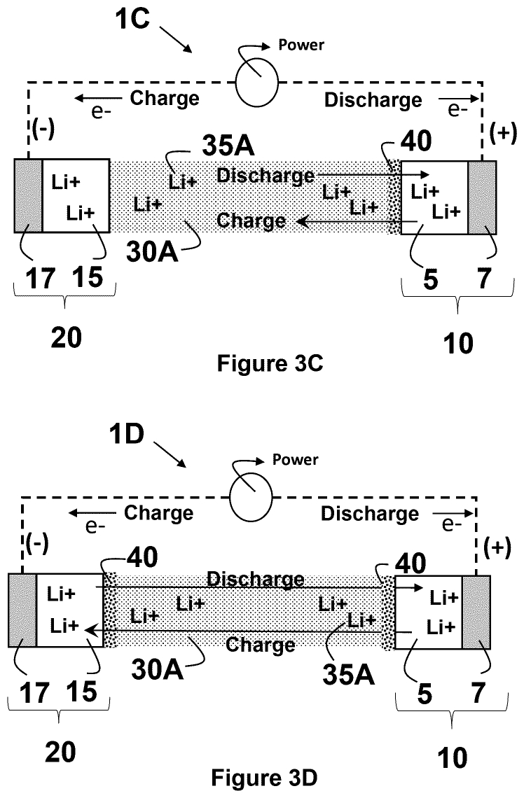

Referring now to FIG. 3A, according to one aspect of the present disclosure, an electrochemical cell 1A is shown that comprises a positive electrode 10, a negative electrode 20, an electrolyte 30, and a separator 40 in the form of a zeolite-based material comprising one or more naturally occurring or synthetically synthesized zeolites applied directly to the negative electrode 20. The positive electrode 10 is configured so that non-reactive metal ions are reversibly extracted there from and inserted therein, while the negative electrode 20 is configured to reversibly accept and release the non-reactive metal ions. Each of the electrodes 10, 20 are generally comprised of a current collector 7, 17 and an active material that acts as either a cathode 5 or an anode 15. As shown in FIG. 3A, the zeolite-based material separator 40 is applied directly to the anode 15. However, it should be understood that the negative electrode 20 may be an “anode-free” electrode, wherein it comprises only a current collector 17, such that the zeolite-based material separator 40 could be applied directly to the current collector 17, without exceeding the scope of the present disclosure.

Still referring to FIG. 3A, the electrolyte 30 is positioned between and in contact with the negative electrode 20 and the positive electrode 10, such that the electrolyte 30 supports a reversible flow of the non-reactive metal ions 35 between the positive electrode 10 and the negative electrode 20. The separator 40 is configured to electrically isolate the positive electrode 10 from the negative electrode 20, while being permeable to the reversible flow of the non-reactive metal ions 35 there through.

Referring now to FIG. 3B, according to other aspect of the present disclosure, the electrochemical cell 1B of FIG. 3B is shown as a secondary cell 1B for use in a lithium-ion secondary battery. In this specific application, the ions 35A that reversibly flow between the anode 15 and the cathode 5 are lithium ions (Li⁺).

Similar to FIG. 3B, both FIGS. 3C and 3D demonstrate an electrochemical cell shown as a secondary cell 1C, 1D for use in a lithium-ion secondary battery. According to one aspect of the present disclosure, the separator 40 formed of the zeolite-based material may be applied directly to the positive electrode 10 or a portion of said electrode, i.e., the cathode 5, as shown in FIG. 3C. Similarly, the zeolite-based material separator 40 may be applied to both the negative electrode 20 (e.g., anode 15) and the positive electrode 10 (e.g., cathode 5), as shown in FIG. 3D.

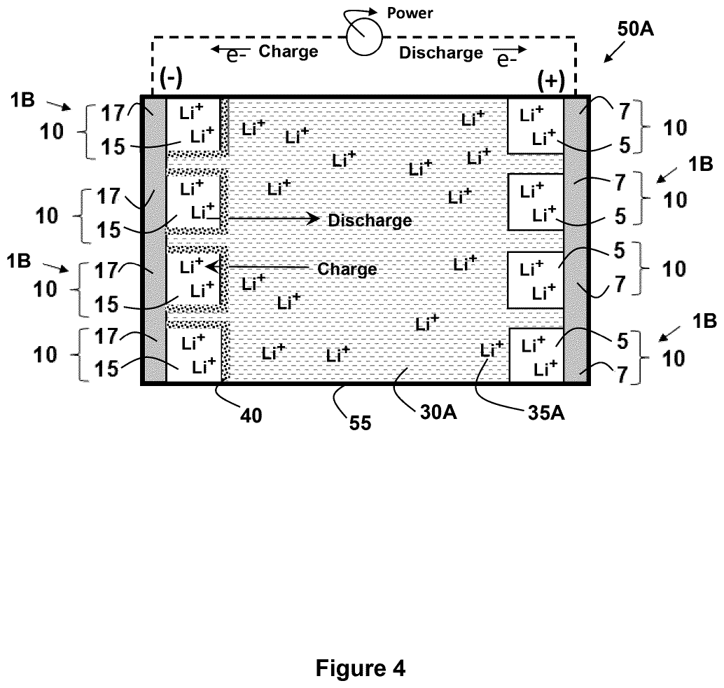

According to yet another aspect of the present disclosure, one or more secondary cells may be combined to form an electrochemical cell, such as a lithium-ion secondary battery. Referring now to FIG. 4, an example of such a battery is shown in which four (4) secondary cells 1B are layered or combined to form a larger single secondary cell that is encapsulated in a housing 55 to produce the lithium-ion secondary battery 50A. The lithium-ion secondary battery 50A includes a housing 60 having an internal wall in which the secondary cells 1B of FIG. 3B are enclosed or encapsulated in order to provide for both physical and environmental protection. One skilled in the art will understand that although the battery 50A shown in FIG. 4 incorporates four secondary cells 1B of FIG. 3B that such a battery 50A may include any other number of such secondary cells 1B. In addition, the secondary cells 1B of FIG. 3B present in the battery 50A may be replaced with the secondary cells 1C of FIG. 3C or with the secondary cells 1D of FIG. 3D.

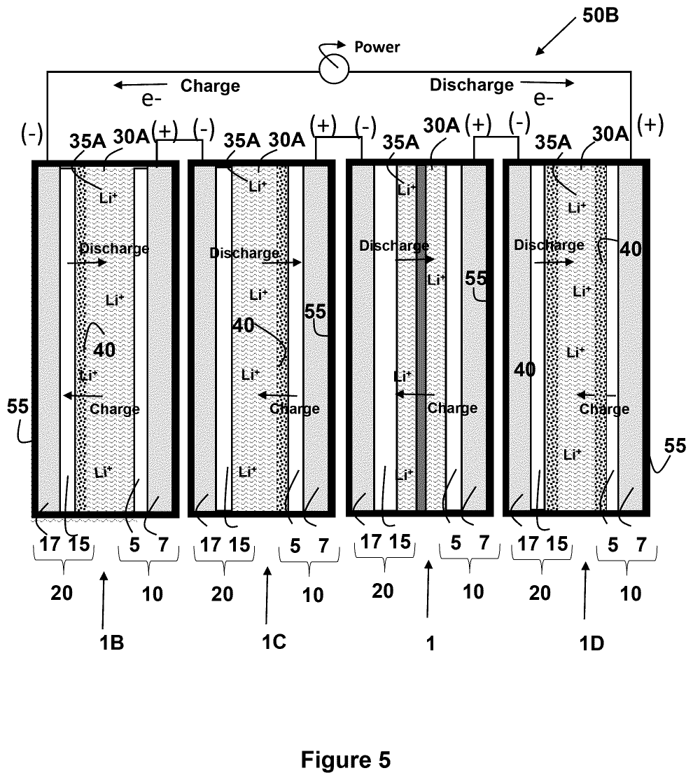

In FIG. 5, another example of a battery 50B is shown, in which four (4) secondary cells are stacked or placed in series to form a larger capacity battery 50B with each cell being individually contained. In this battery 50B, the four secondary cells may comprise one or more of the cells 1B, 1C, 1D shown in FIGS. 3B-3D; alternatively, the secondary cells may include one or more conventional cells 1; alternatively, the secondary cells may include a mixture of the cells 1B, 1C, 1D formed according to the teachings of the present disclosure. As depicted in FIG. 5, the battery 50B is shown to include, as one example, without limitation, a conventional cell 1 and three different cells 1B, 1C, 1D formed according to the teachings of the present disclosure.

One skilled in the art will also appreciate that although FIGS. 4 and 5 demonstrate the incorporation of secondary cells 1B-1D into a lithium-ion secondary battery 50A, 50B, the same principles may be used to encompass or encase one or more electrochemical cells 1A into a housing 55 for use in another application. In these electrochemical cells 1A, the zeolite-based material separator 40 may be applied directly onto one or more of electrodes 10, 20, such as in the form of a coating applied onto the surface of the cathode 5, the anode 15, or a combination thereof.

The housing 55 may be constructed of any material known for such use in the art and be of any desired geometry required or desired for a specific application. For example, lithium-ion batteries generally are housed in three different main form factors or geometries, namely, cylindrical, prismatic, or soft pouch. The housing 55 for a cylindrical battery may be made of aluminum, steel, or the like. Prismatic batteries generally comprise a housing 55 that is rectangular shaped rather than cylindrical. Soft pouch housings 55 may be made in a variety of shapes and sizes. These soft housings may be comprised of an aluminum foil pouch coated with a plastic on the inside, outside, or both. The soft housing 55 may also be a polymeric-type encasing. The polymer composition used for the housing 55 may be any known polymeric materials that are conventionally used in lithium-ion secondary batteries. One specific example, among many, include the use of a laminate pouch that comprises a polyolefin layer on the inside and a polyamide layer on the outside. A soft housing 55 needs to be designed such that the housing 55 provides mechanical protection for the secondary cells present in the battery 50A, 50B.

Due to the large internal surface area, the zeolites may also be used as a support for a secondary material. The ratio of the zeolites to the secondary materials is in a mass ratio ranging from 99.9%/0.1% to 50.1%/49.9%. The secondary materials, may include without limitation, a catalyst and/or a flame retardant.

According to one aspect of the present disclosure, a flame retardant could be loaded inside the pores, such that the zeolite-based material acts as a flame retardant. In this example, the flame retardant should not to be soluble in the organic electrolyte, which is an organic carbonate for lithium ion batteries. The flame retardant material may be selected from a group of inorganic materials, polymer materials, organic-inorganic hybrid materials or organic materials. The traditional flame retardant materials include magnesium hydroxide, aluminum hydroxide, phosphate and bromate may be utilized when desired. Various materials having a large amount of crystalline water may also be selected since the water released at a high temperature will lower the battery temperature and act as a flame retardant.

According to another aspect of the present disclosure, the zeolites may be impregnated or functionalized with a catalyst. This catalyst may be configured to catalyze the polymerization reaction of unsaturated carbonates such as ethylene carbonate, propylene carbonate, or trimethylene carbonate at high temperatures. The catalyst could be, but is not limited to, CeO₂ and sodium stannate trihydrate.

The specific examples provided in this disclosure are given to illustrate various embodiments of the invention and should not be construed to limit the scope of the disclosure. The embodiments have been described in a way which enables a clear and concise specification to be written, but it is intended and will be appreciated that embodiments may be variously combined or separated without parting from the invention.

For example, it will be appreciated that all preferred features described herein are applicable to all aspects of the invention described herein.

### Example 1. Preparation of Zeolite Coated LiMn₂O₄/Zeolite Coated Li₄Ti₅O₁₂ Full Cells and LiMn₂O₄/PE/Li₄Ti₅O₁₂ Reference Cell

Commercial electrode materials including LiMn₂O₄, Li₄Ti₅O₁₂, C65, PVDF (Gelon, China), as well as CNT (C-nano, China) are commercially available. The cathode electrode was made with 92 wt. % LiMn₂O₄, 2 wt. % C₆₅, 2 wt. % CNT, and 4 wt. % of polyvinylidene fluoride (PVDF). The areal capacity loading of the cathode was about 0.8 mAh/cm². The anode electrode was made with 92 wt. % Li₄Ti₅O₁₂, 3 wt. % C65, and 5 wt. % PVDF with an areal capacity loading about 0.8 mAh/cm². For the reference cell, a commercial ceramic oxide-coated polyethylene (PE) separator with 16 μm thickness was used. For the zeolite coating cell, a layer of zeolite-based material with about 15-20 μm thickness after pressing was applied onto both the cathode and the anode electrodes. A full cell was fabricated by stacking the zeolite-coated cathode and the zeolite-coated anode without any commercial separator. The electrolyte was 1.0 M LiPF₆ in ethylene carbonate and diethyl carbonate (EC/DEC ratio of 1/3), 1 wt. % fluoroethylene carbonate (FEC), 1 wt. % vinylene carbonate (VC) from Gelon, China.

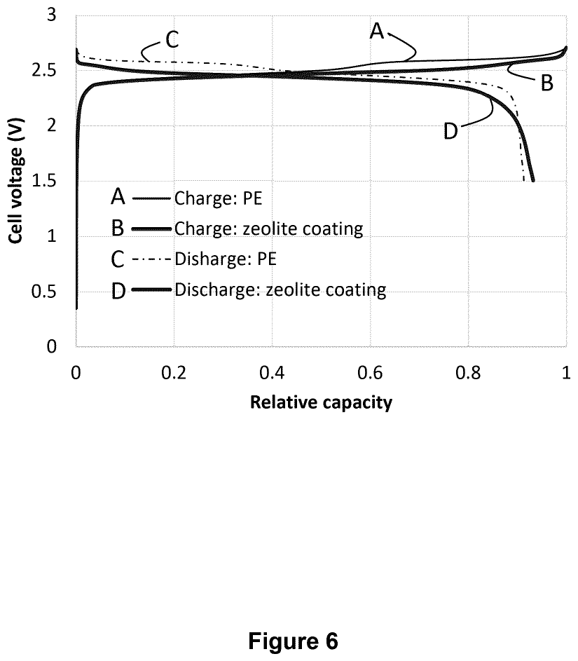

Referring now to FIG. 6, for the electrochemical test, both cells were charged/discharged at room temperature between 1.5 V and 2.7 V at C/10 charge/discharge rates with C/20 tapering at 2.7 V. As shown in FIG. 6, the 1^{st} cycle charge/discharge curves for the full cell containing the zeolite coated electrodes perform similarly to the full cell with a conventional PE separator.

Within this specification, embodiments have been described in a way which enables a clear and concise specification to be written, but it is intended and will be appreciated that embodiments may be variously combined or separated without parting from the invention. For example, it will be appreciated that all preferred features described herein are applicable to all aspects of the invention described herein.

Those skilled-in-the-art, in light of the present disclosure, will appreciate that many changes can be made in the specific embodiments which are disclosed herein and still obtain alike or similar result without departing from or exceeding the spirit or scope of the disclosure. One skilled in the art will further understand that any properties reported herein represent properties that are routinely measured and can be obtained by multiple different methods. The methods described herein represent one such method and other methods may be utilized without exceeding the scope of the present disclosure.

The foregoing description of various forms of the invention has been presented for purposes of illustration and description. It is not intended to be exhaustive or to limit the invention to the precise forms disclosed. Numerous modifications or variations are possible in light of the above teachings. The forms discussed were chosen and described to provide the best illustration of the principles of the invention and its practical application to thereby enable one of ordinary skill in the art to utilize the invention in various forms and with various modifications as are suited to the particular use contemplated. All such modifications and variations are within the scope of the invention as determined by the appended claims when interpreted in accordance with the breadth to which they are fairly, legally, and equitably entitled.

1. A cell for use in an electrochemical cell, the electrochemical cell comprising:
a positive electrode, the positive electrode configured so that non-reactive metal ions are reversibly extracted there from and inserted therein;
a negative electrode, the negative electrode configured to reversibly accept and release the non-reactive metal ions;
an electrolyte positioned between and in contact with the negative electrode and the positive electrode; wherein the electrolyte supports a reversible flow of the non-reactive metal ions between the positive electrode and the negative electrode; and
a separator in the form of a zeolite-based material comprising one or more naturally occurring or synthetically synthesized zeolites applied directly to at least one of the positive electrode and the negative electrode, the separator configured to electrically isolate the positive electrode from the negative electrode, while being permeable to the reversible flow of the non-reactive metal ions there through.

2. The cell according to claim 1, wherein the zeolite-based material applied to the at least one of the positive electrode and negative electrode has a thickness in the range from 1 micrometers (μm) to 200 μm.

3. The cell according to claim 1, wherein the positive electrode comprises an active material as a cathode and a current collector that is in contact with the cathode; wherein the active material comprises one or more of LMNO, LiMn₂O₄, LiFePO₄, LiNiₐCo_{b}Mn_{c}Al_{d}O₂ (a+b+c+d=1), and LiFe_{0.2}Mn_{0.8}PO₄.

4. The cell according to claim 1, wherein the negative electrode comprises an active material as an anode and a current collector that is in contact with the anode; wherein the active material comprises one or more of graphite, hard carbon, soft carbon, silicon, Li₄Ti₅O₁₂, Nb₂O₅, and derivatives thereof.

5. The cell according to claim 1, wherein the negative electrode is an “anode-free” electrode and comprises only a current collector.

6. The cell according to claim 1, wherein the zeolite-based material has a moisture content that is 35% or less.

7. The cell according to claim 6, wherein the zeolite-based material has a moisture content that is 7% or less.

8. The cell according to claim 1, wherein the zeolite-based material has a porosity that is 55% or less.

9. The cell according to claim 8, wherein the porosity of the zeolite-based material is in the range of 30% to 36%.

10. The cell according to claim 1, wherein the zeolite-based material further comprises a binder, such that the ratio of the zeolites to the binder is in a mass ratio ranging from 99.5%/0.5% to 10%/90%.

11. The cell according to claim 10, wherein the binder comprises an organic complex, an inorganic oxide, or an inorganic hydroxide.

12. The cell according to claim 11, wherein the organic complex is PVDF, cmc, SBR, PTFE, PAA (polyacrylic acid), PVA, PEI, or PAI; wherein the inorganic oxide or the inorganic hydroxide includes aluminum, magnesium, zirconium, or cerium as an element thereof.

13. The cell according to claim 1, wherein the zeolite-based material further comprises one or more secondary materials; wherein the ratio of the zeolites to the secondary materials is in a mass ratio ranging from 99.9%/0.1% to 50.1%/49.9%.

14. The cell according to claim 13, wherein the one or more secondary materials includes a flame retardant material.

15. The cell according to claim 1, wherein the zeolites have an average particle size that is in the range of 50 nanometers (nm) to 30 micrometers (μm).

16. The cell according to claim 1, wherein the zeolites comprise one or more ion-exchanged zeolites.

17. The cell according to claim 16, wherein the ion-exchanged zeolites are lithium-exchanged zeolites comprising a lithium mass content that is in the range of 0.1 wt. % to 20 wt. % relative to the overall weight of the lithium-exchanged zeolites.

18. (canceled)

19. The cell according to claim 1, wherein the zeolites comprise at least one of the following:
an average pore size that is in the range of 0.1 nm to 20 nm; or
an aluminum to silicon ratio (SAR) that is in the range of 0.5 to 500.

20. (canceled)

21. The cell according to claim 1, wherein the non-reactive metal ion in the electrolyte is lithium, sodium, potassium, magnesium, calcium, aluminum, or a mixture thereof.

22. A lithium-ion secondary battery comprising:
one or more cells according to claim 1; and
one or more housings, such that an internal wall from one of the one or more housings encapsulates at least one or more of the cells.
